(19) United States
(12) Patent Application Publication
(10) Pub. No.: US 2022/0264506 A1
(43) Pub. Date: Aug. 18, 2022

(54) Systems and Methods for Multiple Universal Subscriber Identity Module (MUSIM) Capability Signaling and Enhanced Features

(71) Applicant: Apple Inc., Cupertino, CA (US)

(72) Inventors: Krisztian Kiss, Hayward, CA (US); Anikethan Ramakrishna Vijaya Kumar, Mysuru (IN); Karthik Ramamurthy, Bangalore (IN); Nirlesh Koshta, Bangalore (IN); Shashanka Totadamane Ramappa, Shivamogga (IN); Sridhar Prakasam, Fremont, CA (US); Vijay Venkataraman, San Jose, CA (US); Xiangpeng Jing, Palo Alto, CA (US)

(21) Appl. No.: 17/650,799

(22) Filed: Feb. 11, 2022

(30) Foreign Application Priority Data
Feb. 17, 2021 (IN) 202111006616

(51) Int. Cl. H04W 60/00; H04W 68/02; H04W 76/15

(52) U.S. Cl. CPC H04W 60/00; H04W 88/06; H04W 76/15; H04W 68/02

(57) ABSTRACT

A technique for determining that a wireless device supports using multiple subscriber identity module (SIM) cards to establish multiple connections to wireless networks, generating a multi-SIM capability message, transmitting the multi-SIM capability message to a first wireless network; and receiving a registration accept signal in response to the multi-SIM capability message, wherein the registration accept signal indicates a first set of features supported by the first wireless network. In another aspect, a technique for a wireless system to receive, via a network interface, a multiple subscriber identity module (multi-SIM) capability message from a wireless device connected to a first wireless network; generate a registration accept signal in response to receiving the multi-SIM capability message, wherein the registration accept signal indicates a first set of features supported by the first wireless network; and send, via the network interface, the registration accept signal to the wireless device.

### FIELD

The present application relates to wireless devices and wireless networks including devices, computer-readable media, and methods for implementing a framework for Multiple Universal Subscriber Identity Module (MUSIM) capability signaling and enhanced features related thereto.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Aspects relate to devices, computer-readable media, and methods for a wireless device capable of determining that the wireless device supports using multiple subscriber identity module (SIM) cards (referred to herein as a “MUSIM” or “multi-SIM” device capability) to establish multiple connections to wireless networks, generating a multi-SIM capability message, transmitting the multi-SIM capability message to a first wireless network; and receiving a registration accept signal in response to the multi-SIM capability message, wherein the registration accept signal indicates a first set of features supported by the first wireless network.

Aspects also relate to devices, computer-readable media, and methods for a wireless system apparatus capable of receiving, via a network interface, a multiple subscriber identity module (multi-SIM) capability message from a wireless device connected to a first wireless network; generating a registration accept signal in response to receiving the multi-SIM capability message, wherein the registration accept signal indicates a first set of features supported by the first wireless network; and sending, via the network interface, the registration accept signal to the wireless device.

The first set of features supported by the first wireless network may, e.g., comprise at least one of the following: a paging cause feature; a Non-Access Stratum (NAS) busy indication feature; a paging collision avoidance feature; a NAS leaving procedure feature; a NAS resume procedure feature; or a paging filtering indication feature. The set of features supported by a given wireless device may be the same as, or different in some way, than the set of features supported by the first wireless network. Various MUSIM (and single-USIM) wireless device feature enhancements, optimizations, and procedures for both 5G and LTE networks will be described herein.

The techniques described herein may be implemented in and/or used with a number of different types of devices, including but not limited to cellular phones, wireless devices, tablet computers, wearable computing devices, portable media players, and any of various other computing devices, including network elements and computer servers.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter can be obtained when the following detailed description of various aspects is considered in conjunction with the following drawings.

FIG. 1 illustrates an example wireless communication system, according to some aspects.

FIG. 2 illustrates a base station (BS) in communication with a user equipment (UE) device, according to some aspects.

FIG. 3 illustrates an example block diagram of a UE, according to some Aspects.

FIG. 4 illustrates an example block diagram of a BS, according to some aspects.

FIG. 5 illustrates an example block diagram of cellular communication circuitry, according to some aspects.

FIG. 6 illustrates an example block diagram of a network element, according to some aspects.

FIG. 7A illustrates an example of connections between an evolved packet core (EPC) network, an LTE base station (NB), and a 5G NR base station (gNB), according to some aspects.

FIG. 7B illustrates an example of a protocol stack for an eNB and a gNB, according to some aspects.

FIG. 8 illustrates an example of a baseband processor architecture for a UE, according to some aspects.

FIG. 9 is a message sequence diagram illustrating multi-SIM indications, in accordance with aspects of the present disclosure.

FIG. 10 is a message sequence diagram illustrating multi-SIM indications, in accordance with aspects of the present disclosure.

FIG. 11 is a flowchart illustrating a technique for receiving multi-SIM feature indications, in accordance with aspects of the present disclosure.

FIG. 12 is a flowchart illustrating a technique for generating multi-SIM feature indications, in accordance with aspects of the present disclosure.

FIG. 13 is a message sequence diagram illustrating multi-SIM wireless device NAS busy indication, in accordance with aspects of the present disclosure.

FIG. 14 is a message sequence diagram illustrating optimized multi-SIM wireless device NAS busy indication, in accordance with aspects of the present disclosure.

FIG. 15 is a message sequence diagram illustrating multi-SIM wireless device NAS busy/leaving indication with multiple wireless networks, in accordance with aspects of the present disclosure.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In certain wireless communications systems, a wireless device may support multiple SIM cards, allowing the wireless device to maintain multiple simultaneous wireless connections to different wireless networks using the SIM cards. In some cases, the multiple wireless connections may have conflicting configurations for the wireless device, or the configurations may be optimized to improve performance, such as battery life, of the wireless device. In other cases, the wireless networks themselves may support different functionality and procedures. What is needed is a framework for multi-SIM capability signaling for wireless devices and wireless networks that allows for various reconfiguration and optimizations for MUSIM-related functionality, especially with regard to the provision of paging causes, paging collision avoidance, paging filtering, and NAS busy indications, as well as NAS leaving and resuming procedures.

The following is a glossary of terms that may be used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (also “User Device” or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, Play Station Portable™, Gameboy Advance™ iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, etc. In general, the term “UE” or “UE device” can be broadly defined to encompass any electronic, computing, and/or telecommunications device (or combination of devices) which is transportable by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “base station” or “wireless station” has the full breadth of its ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” etc., may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” etc., are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some aspects, “approximately” may mean within 0.1% of some specified or desired value, while in various other aspects, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

Example Wireless Communication System

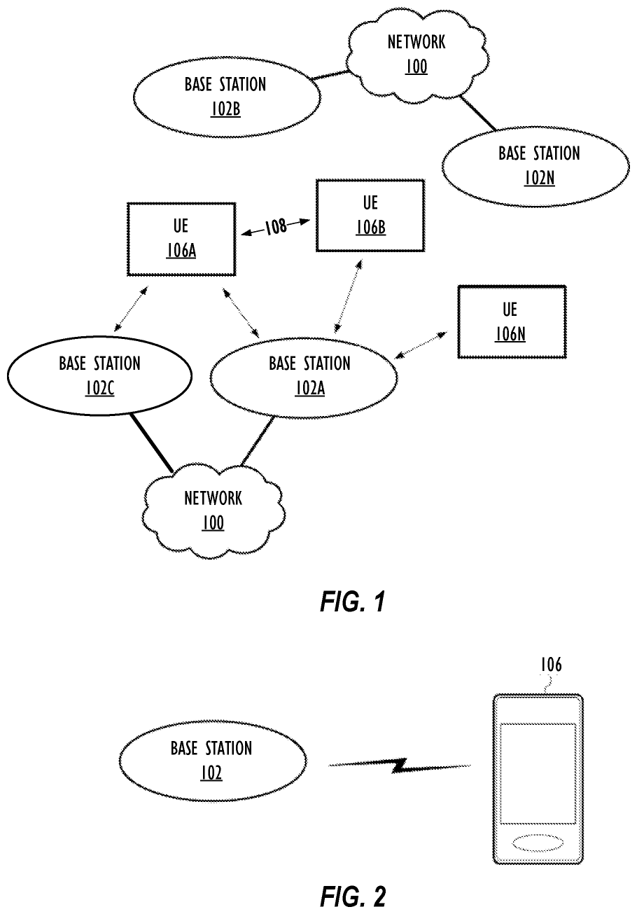

Turning now to FIG. 1, a simplified example of a wireless communication system is illustrated, according to some aspects. It is noted that the system of FIG. 1 is merely one example of a possible system, and that features of this disclosure may be implemented in any of various systems, as desired.

As shown, the example wireless communication system includes a base station 102A, which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some embodiments, the UEs 106 may be IoT UEs, which may comprise a network access layer designed for low-power IoT applications utilizing short-lived UE connections. An IoT UE can utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, etc.) to facilitate the connections of the IoT network.

As shown, the UEs 106, such as UE 106A and UE 106B, may directly exchange communication data via a PC5 interface 108. The PC5 interface 105 may comprise one or more logical channels, including but not limited to a physical sidelink shared channel (PSSCH), a physical sidelink control channel (PSCCH), a physical sidelink shared channel (PSSCH), a physical sidelink downlink channel (PSDCH), a physical sidelink broadcast channel (PSBCH), and a physical sidelink feedback channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB.” In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

Example User Equipment (UE)

FIG. 2 illustrates user equipment 106 (e.g., one of the devices 106A through 106N) in communication with a base station 102, according to some aspects. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some embodiments, a downlink resource grid can be used for downlink transmissions from any of the base stations 102 to the UEs 106, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher-layer signaling to the UEs 106. The physical downlink control channel (PDCCH) may carry information about the transport format and resource allocations related to the PDSCH channel, among other things. It may also inform the UEs 106 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Example Communication Device

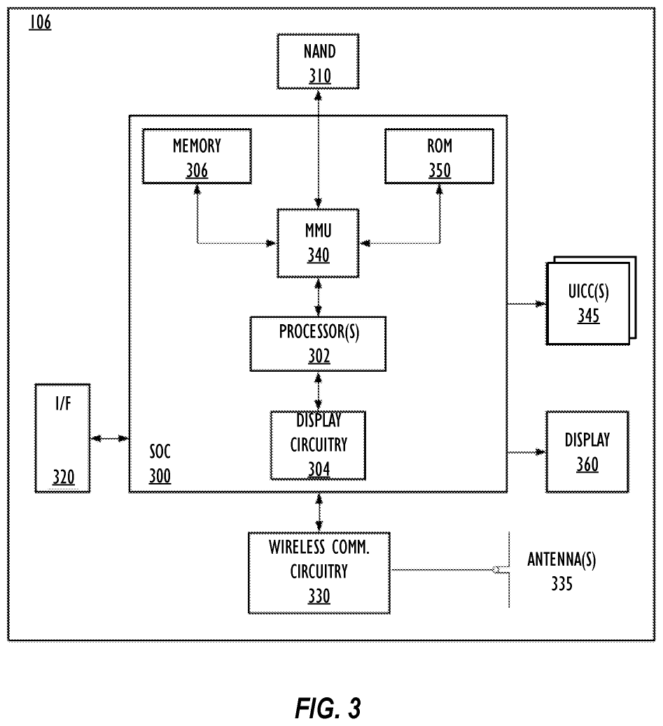

FIG. 3 illustrates an example simplified block diagram of a communication device 106, according to some aspects. It is noted that the block diagram of the communication device of FIG. 3 is only one example of a possible communication device. According to aspects, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some aspects, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some aspects, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality (e.g., SIM card), such as one or more UICC(s) (Universal Integrated Circuit Card(s)) cards, one or more universal subscriber identity module (USIM), and/or one or more embedded SIM (eSIM). In some cases, the SIM cards may be a separate card which may be placed within the communication device 106, or built in (e.g., embedded) to the communication device 106. The communication device 106 may be configured with any combination of one or more eSIMs and/or separate SIM cards. In this example, the communication device includes two smart cards 345. The smart cards 345 include an international mobile subscriber identity (IMSI) number and associated security key. The IMSI number may be used to identify and authenticate the communication device 106 with a wireless network. In cases where the communication device 106 includes multiple smart cards 345, the communication device 106 may be able to establish separate connections to wireless networks with each smart card 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

Example Base Station

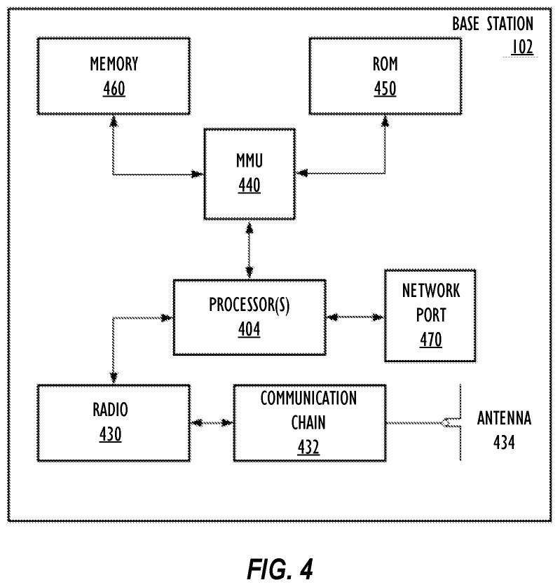

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB.” In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

Example Cellular Communication Circuitry

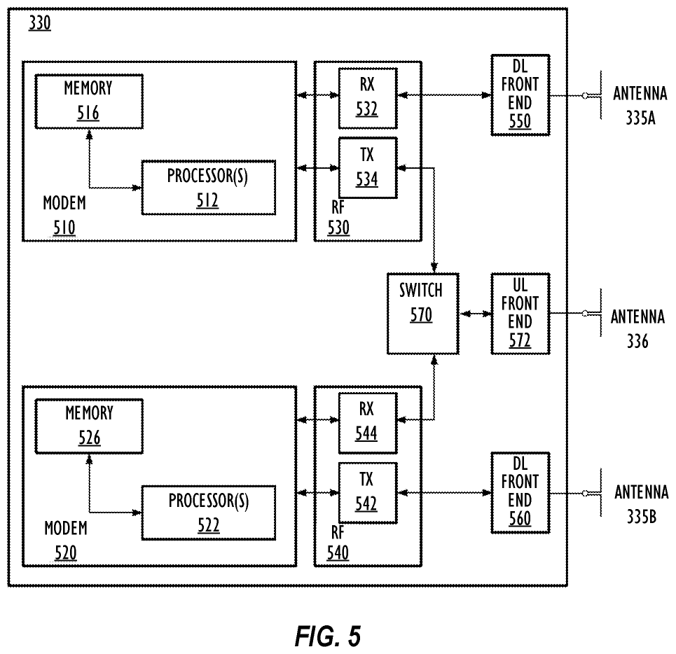

FIG. 5 illustrates an example simplified block diagram of cellular communication circuitry, according to some aspects. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some aspects, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some aspects, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some aspects, the cellular communication circuitry 330 may also not include the switch 570, and the RF front end 530 or the RF front end 540 may be in communication, e.g., directly, with the UL front end 572.

Example Network Element

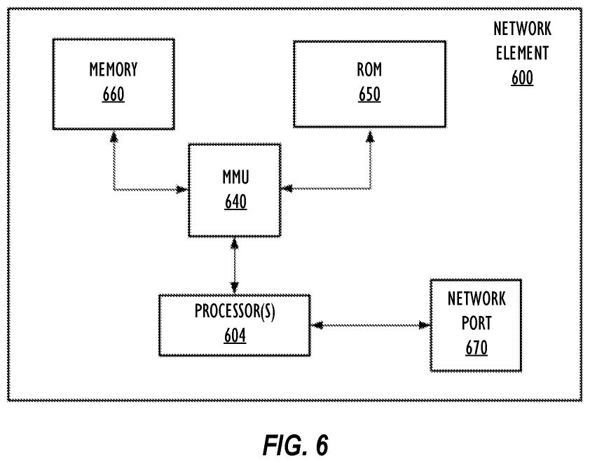

FIG. 6 illustrates an exemplary block diagram of a network element 600, according to some aspects. According to some aspects, the network element 600 may implement one or more logical functions/entities of a cellular core network, such as a mobility management entity (MME), serving gateway (S-GW), access and management function (AMF), session management function (SMF), user plane function (UPF), network slice quota management (NSQM) function, etc. It is noted that the network element 600 of FIG. 6 is merely one example of a possible network element 600. As shown, the core network element 600 may include processor(s) 604 which may execute program instructions for the core network element 600. The processor(s) 604 may also be coupled to memory management unit (MMU) 640, which may be configured to receive addresses from the processor(s) 604 and translate those addresses to locations in memory (e.g., memory 660 and read only memory (ROM) 650) or to other circuits or devices.

The network element 600 may include at least one network port 670. The network port 670 may comprise a network interface and be configured to couple to one or more base stations and/or other cellular network entities and/or devices. The network element 600 may communicate with base stations (e.g., eNBs/gNBs) and/or other network entities/devices by means of any of various communication protocols and/or interfaces.

As described further subsequently herein, the network element 600 may include hardware and software components for implementing and/or supporting implementation of features described herein. The processor(s) 604 of the core network element 600 may be configured to implement or support implementation of part or all of the methods described herein, e.g., by executing program instructions stored on a memory medium (e.g., a nontransitory computer-readable memory medium). Alternatively, the processor 604 may be configured as a programmable hardware element, such as an FPGA (Field Programmable Gate Array), or as an ASIC (Application Specific Integrated Circuit), or a combination thereof.

5G-NR Architecture with LTE

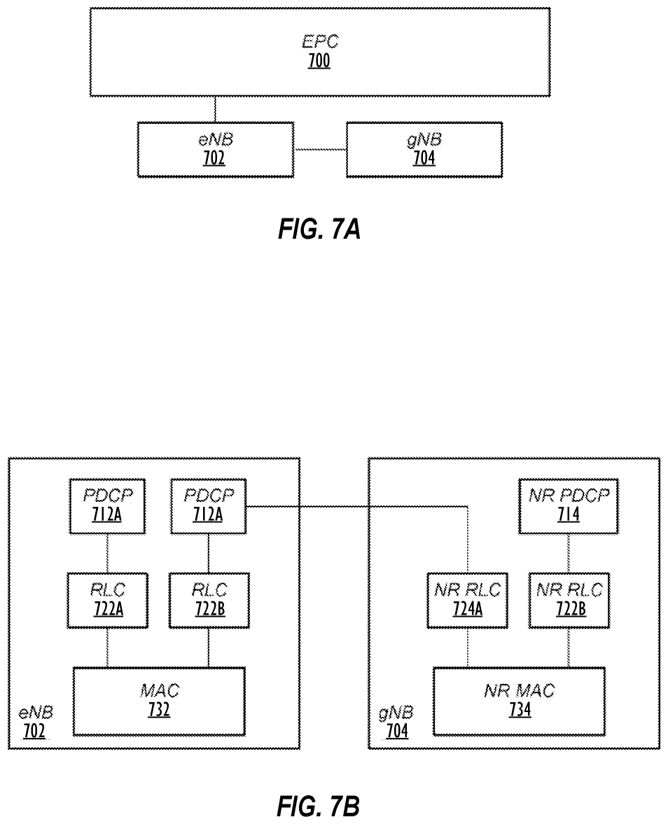

In some implementations, fifth generation (5G) wireless communication will initially be deployed concurrently with current wireless communication standards (e.g., LTE). For example, dual connectivity between LTE and 5G new radio (5G NR or NR) has been specified as part of the initial deployment of NR. Thus, as illustrated in FIGS. 7A-B, evolved packet core (EPC) network 700 may continue to communicate with current LTE base stations (e.g., eNB 702). In addition, eNB 702 may be in communication with a 5G NR base station (e.g., base station 704) and may pass data between the EPC network 700 and base station 704. Thus, EPC network 700 may be used (or reused) and base station 704 may serve as extra capacity for UEs, e.g., for providing increased downlink throughput to UEs. In other words, LTE may be used for control plane signaling and NR may be used for user plane signaling. Thus, LTE may be used to establish connections to the network and NR may be used for data services.

FIG. 7B illustrates a proposed protocol stack for eNB 702 and base station 704. As shown, eNB 702 may include a medium access control (MAC) layer 732 that interfaces with radio link control (RLC) layers 722A-b. RLC layer 722A may also interface with packet data convergence protocol (PDCP) layer 712 a and RLC layer 722B may interface with PDCP layer 712B. Similar to dual connectivity as specified in LTE-Advanced Release 12, PDCP layer 712A may interface via a master cell group (MCG) bearer to EPC network 700 whereas PDCP layer 712B may interface via a split bearer with EPC network 700.

Additionally, as shown, base station 704 may include a MAC layer 734 that interfaces with RLC layers 724A-b. RLC layer 724A may interface with PDCP layer 712B of eNB 702 via an X2 interface for information exchange and/or coordination (e.g., scheduling of a UE) between eNB 702 and base station 704. In addition, RLC layer 724B may interface with PDCP layer 714. Similar to dual connectivity as specified in LTE-Advanced Release 12, PDCP layer 714 may interface with EPC network 700 via a secondary cell group (SCG) bearer. Thus, eNB 702 may be considered a master node (MeNB) while base station 704 may be considered a secondary node (SgNB). In some scenarios, a UE may be required to maintain a connection to both an MeNB and a SgNB. In such scenarios, the MeNB may be used to maintain a radio resource control (RRC) connection to an EPC while the SgNB may be used for capacity (e.g., additional downlink and/or uplink throughput).

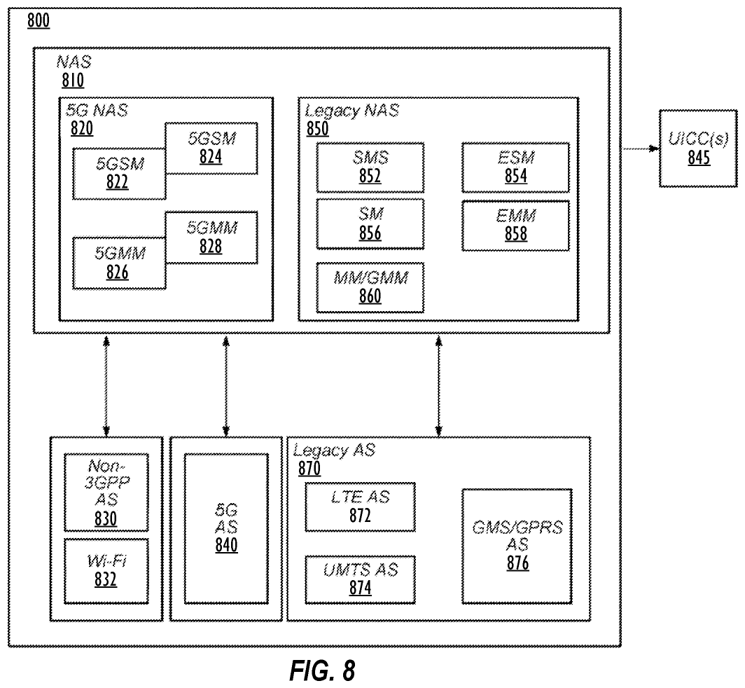

FIG. 8 illustrates an example of a baseband processor architecture for a UE (e.g., such as UE 106), according to some aspects. The baseband processor architecture 800 described in FIG. 8 may be implemented on one or more radios (e.g., wireless communication circuitry 330 described above) or modems (e.g., modems 510 and/or 520) as described above. As shown, the non-access stratum (NAS) 810 may include a 5G NAS 820 and a legacy NAS 850. The legacy NAS 850 may include a communication connection with a legacy access stratum (AS) 870. The 5G NAS 820 may include communication connections with both a 5G AS 840 and a non-3GPP AS 830 and Wi-Fi AS 832. The 5G NAS 820 may include functional entities associated with both access stratums. Thus, the 5G NAS 820 may include multiple 5G MM entities 826 and 828 and 5G session management (SM) entities 822 and 824. The legacy NAS 850 may include functional entities such as short message service (SMS) entity 852, evolved packet system (EPS) session management (ESM) entity 854, session management (SM) entity 856, EPS mobility management (EMM) entity 858, and mobility management (MM)/GPRS mobility management (GMM) entity 860. In addition, the legacy AS 870 may include functional entities such as LTE AS 872, UMTS AS 874, and/or GSM/GPRS AS 876.

Thus, the baseband processor architecture 800 allows for a common 5G-NAS for both 5G cellular and non-cellular (e.g., non-3GPP access). Note that, as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that, in various embodiments, one or more of the above described elements may be configured to perform methods to implement mechanisms for a multi-SIM capability signaling framework, e.g., as further described herein.

Wireless Device Attach/Registration

A communication device (e.g., a wireless device or UE) may connect to one or more wireless elements through an attachment or registration process. For example, a wireless device connecting using an LTE communication standard may perform an attach procedure to connect to an eNB. Similarly, a wireless device connecting via a NR or 5G communication standard may perform a registration procedure to connect to a gNB. The attach/registration procedure of LTE and 5G NR are broadly similar. The wireless device may perform the registration/attach procedure when the wireless device initially attempts to connect to the wireless network, such as after being powered on, or when the appropriate radio is switched on, such as when airplane more is turned off. Initially, the wireless device may sense the physical medium for basic configuration and synchronization information related to the wireless node, such a time/frequency resources, root sequences, cyclic shifts, etc., which may be broadcast by the wireless network. The wireless device may then transmit an initial registration/attach request message to the wireless network, which may be referred to a msg1. Reception of msg1 by the wireless node may start a sequence of message exchanges between the wireless device and wireless node to connect the wireless device to the wireless network. This sequence of messages help set up aspects of the connection, such as RRC connection, physical layer channels, encoding and decoding information, assign resources, etc. In some wireless networks, such as 5G NR networks, the registration request process may be performed: during initial registration of the UE with the network, for a mobility registration update, or as part of a periodic registration update.

In some cases, a wireless connection between a wireless device and a wireless system may include multiple protocol layers. These layers may include an access stratus (AS) layer and a non-access stratum (NAS) layer. The AS layer controls the connection as between the wireless device and the wireless node. The AS layer includes radio link control (RLC), radio resource control (RRC) messaging, media access control (MAC), etc. The NAS layer may be used to for communications as between the wireless device and core network, such as the MME, S-GW, AMF, SMF, UPF, etc.

Multi-SIM (MUSIM) Operation

Subscriber identity module (SIM) cards are integrated circuits, which store data used to identify and authenticate a user on some wireless networks. A SIM card may be a separate card that is placed into a wireless device, or the SIM card may be built into the wireless device (e.g., an embedded SIM card). Many wireless devices have an ability to utilize multiple SIM cards. Having multiple SIM cards allows a wireless device to potentially maintain concurrent multiple wireless connections to multiple wireless networks. For example, a wireless device with two SIM cards may be able to connect to two different wireless carriers substantially concurrently. As another example, the wireless device with two SIM cards may be able to establish two separate connections to the same wireless carrier, each connection associated with a separate account, such as a work and personal account and phone number. For clarity, this disclosure will refer to operations with two SIMs (e.g., dual SIM), but the concepts discussed herein also apply to operations with additional (e.g., three or more) SIM cards.

There are many different implementations of multi-SIM (e.g., dual SIM) support on wireless devices. The most comprehensive implementation of dual-SIM may include separate transmit (TX) chains and receive (RX) chains for each SIM. Thus, such a dual SIM wireless device would include two TX chains and two RX chains with a separate TX chain and corresponding RX chain for each SIM. Similarly, some cases, wireless devices may be configured in a dual receive configuration where each SIM would be configured with a separate RX chain and a TX chain may be shared by the SIM. Thus, the radio of the wireless device may include two RX chains and a single TX chain. A wireless device with two RX chains and a single TX chain may be able to receive two transmissions, such as from two separate wireless networks, concurrently and transmit to one wireless network at a time.

However, maintaining a multiple TX/RX chains is relatively costly in terms of the including the extra components and power draw of those components. Instead, a dual SIM wireless device may be configured with a single RX chain and a single TX chain for both SIMs. Such a device may be able to receive a transmission from one wireless network at a time and transmit to one wireless network associated with one SIM instance at a time. As there is one RX chain, the wireless device tunes away from a first wireless network, associated with a first SIM, to transmit and receive data from a second wireless network, associated with a second SIM. Dual SIM operations with a single TX/RX chain can be challenging, as currently there is no mechanism to allow coordination between the wireless networks being accessed with each SIM. Thus, if the wireless device is monitoring paging occasions for both wireless networks, there is no mechanism to ensure that the paging occasions for one wireless network do not occur at the same time as the paging occasions for the other wireless network.

Moreover, newly-developed optional enhanced MUSIM-related features may require new UE-network interactions in order to exchange MUSIM capability information between UE and network. For example, a UE may not be able to use new MUSIM-related features on a particular PLMN until it learns that the PLMN supports those particular features. What is needed is a framework for multi-SIM capability exchange and enhanced features related thereto.

Multi-SIM Capability Exchange Framework

In accordance with aspects of the present disclosure, a wireless device and/or wireless network may indicate its multi-SIM capabilities as a part of wireless device capability exchange (e.g., in the form of an indicated set of supported features). Based on an indication that a wireless device has MUSIM support, the wireless network can then indicate one or more MUSIM-related features that it supports. Exemplary MUSIM-related features that may be supported by a wireless network may, e.g., comprise at least one of the following: a paging cause feature; a Non-Access Stratum (NAS) busy indication feature; a paging collision avoidance feature; a NAS leaving procedure feature; a NAS resume procedure feature; or a paging filtering indication feature. The set of features supported by a given wireless device may be the same as, or different in some way, than the set of features supported a given wireless network. Based on the common features supported by both a wireless device and a wireless network it is connected to, various enhancements and optimizations to wireless device and network operations may be provided, as will be described in further detail below.

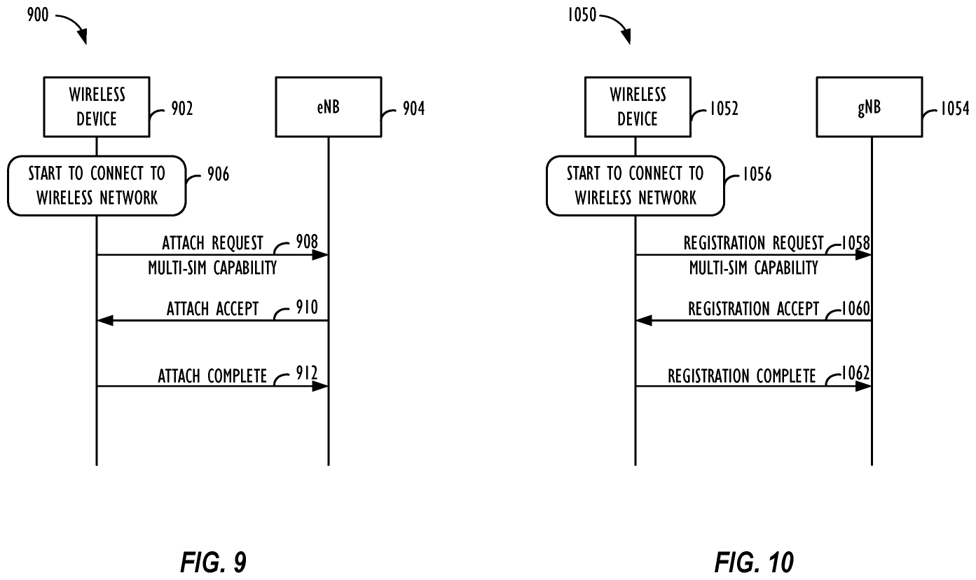

FIGS. 9-10 are message sequence diagrams illustrating multi-SIM indications, in accordance with aspects of the present disclosure. An attach procedure for LTE is illustrated in message sequence chart 900 showing messages between a wireless device 902 and an LTE eNB 904. One or more wireless nodes may transmit and/or receive the messages shown and processing of the messages may be performed by one or more network components, such as those described with respect to FIGS. 7A and 7B. A radio of the wireless device is powered on and begins to attempt to connect 906 to the wireless network. For example, the wireless device may be powered on, airplane mode may be turned off, a wireless radio powered on or when the current SIM configuration is modified, such as when a new physical SIM card is inserted, an eSIM profile enabled, when an existing physical SIM card is removed, an eSIM profile disabled, etc. In some cases, the wireless device may sense the physical medium for basic configuration and/or synchronization information for an LTE based wireless network. For example, in LTE, the wireless device may tune to certain radio frequencies, search for a master information block (MIB) and system information blocks (SIBs), decode the received blocks, generate a msg1 based on the received blocks, and transmit the msg1 to a wireless node to begin an initial attach procedure with the wireless network to establish an RRC connection.

Once the RRC connection is established, the wireless device may transmit an RRC connection setup complete message along with an attach request 908 to the wireless network. This attach request 908 may also include wireless device (UE) radio access capability information. The UE radio access capability information may be extended to include an indication of the multiple-SIM capabilities of the wireless device (e.g., maintaining connections to wireless networks using more than one SIM cards). The eNB 904 may respond to the attach request 908 with an attach accept message 910. According to some aspects, the attach accept message 910 may also be extended to include an indication (e.g., in the form of a bitmap) of the multiple-SIM capabilities of the wireless network (e.g., support for a paging cause feature; support for a NAS busy indication feature; support for a paging collision avoidance feature; support for a NAS leaving procedure feature; support for a NAS resume procedure feature; or support for a paging filtering indication feature, including paging filtering for occasions other than NAS busy/NAS leaving). Finally, the wireless device 902 may respond to the attach accept message 910 with an attach complete message 912. Of note, there may be multiple messages exchanged as between the wireless device 902 and the eNB 904 between the attach request 908 and attach accept message 910, as well as the attach accept message 910 and the attach complete message 912, which may have been omitted in this discussion for clarity.

A registration procedure for 5G NR is illustrated in message sequence chart 1050 of FIG. 10, showing messages between a wireless device 1052 and an NR gNB 1054. As with LTE, one or more wireless nodes may transmit and/or receive the messages shown and processing of the messages may be performed by one or more network components such as those described with respect to FIG. 7A and. In NR, a radio of the wireless device is powered on and begins to attempt to connect 1056 to the wireless network. For example, the wireless device may be powered on, airplane mode may be turned off, a wireless radio powered on, when the current SIM configuration is modified, such as when anew physical SIM card is inserted, an eSIM profile enabled, when an existing physical SIM card is removed, an eSIM profile disabled, etc. In some cases, the wireless device may sense the physical medium for basic configuration and/or synchronization information for an 5G NR based wireless network. For example, in 5G NR, the wireless device may tune to certain radio frequencies, pick a random access preamble, and transmit the random access preamble to a wireless node to begin an initial connection procedure with the wireless network to establish an RRC connection.

Similar to LTE, once the RRC connection is established, the wireless device may transmit an RRC connection setup complete message along with a registration request 1058 to the wireless network. This registration request 1058 may also include wireless device (UE) capability information, such as 5G mobility management (5GMM) information, as well as UE security capability information. This UE capability information may also be extended to include an indication of the multi-SIM capabilities of the wireless device. The gNB 1054 may respond to the registration request 1058 with a registration accept message 1060. Similar to LTE, according to some aspects, the registration accept message 1060 may also be extended to include an indication (e.g., in the form of a bitmap) of the multiple-SIM capabilities of the wireless network (e.g., support for a paging cause feature; support for a NAS busy indication feature; support for a paging collision avoidance feature; support for a NAS leaving procedure feature; support for a NAS resume procedure feature; or support for a paging filtering indication feature, including paging filtering for occasions other than NAS busy/NAS leaving). Finally, the wireless device 1062 may respond to the registration accept message 1060 with a registration complete message 1062. Of note, there may also be multiple messages exchanged as between the wireless device 1062 and the eNB 1054 between the registration request 1058 and registration accept message 1060, as well as the registration accept message 1060 and registration complete message 1062 that may have been omitted in this discussion for clarity.

As discussed above, in some cases, multi-SIM capability information may be conveyed between the wireless device and the wireless network as a part of the attach/registration procedure at a NAS level. In some cases, the multi-SIM capability information may be transmitted without being requested by the wireless network. In some cases, the multi-SIM capability information may be transmitted on demand. For example, in some cases, it may be beneficial to transmit the multi-SIM capability information each time a wireless device connects to a wireless network, while, in other cases, it may be preferable to transmit the multi-SIM capability information from a wireless device to a wireless network only if the wireless network is capable of using such data. In still other cases, for certain features, there may be no need for the wireless device to indicate its capability to the wireless network.

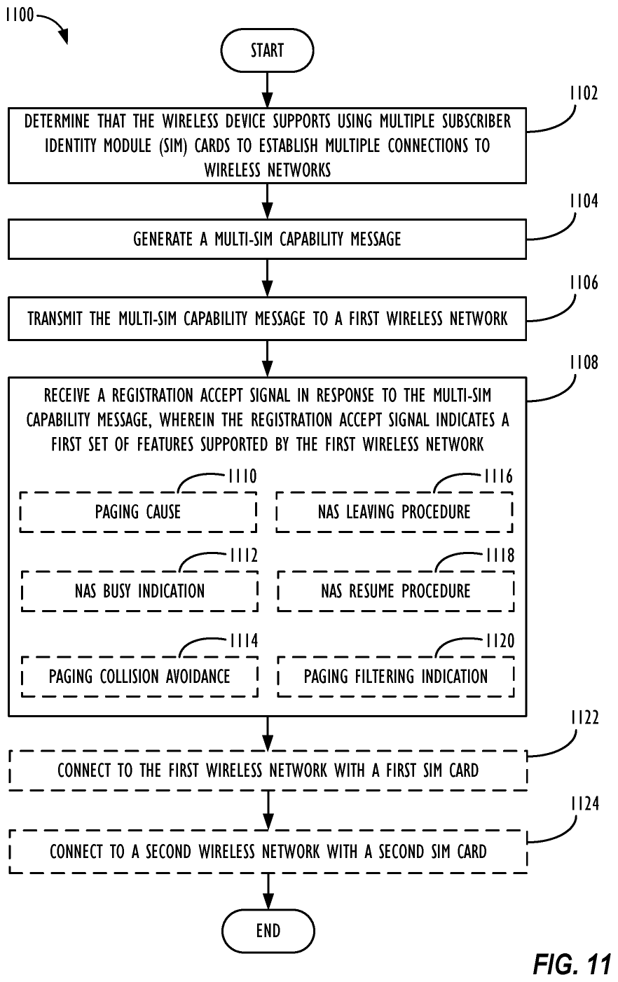

Turning now to FIG. 11, a flowchart 1100 is shown, illustrating a technique for receiving multi-SIM feature indications, in accordance with aspects of the present disclosure. At block 1102, a wireless device determines that the wireless device supports using multiple subscriber identity module (SIM) cards to establish multiple connects to wireless networks. For example, the wireless device may be configured to support multiple SIM cards. The SIM cards may be a separate card that may be placed in the wireless device, or an embedded SIM card. At block 1104, the wireless device generates a multi-SIM capability message. In some cases, this multi-SIM capability message may indicate one or more types of wireless networks supported for each SIM card. In some cases, the multi-SIM capability message includes an indication that the wireless device can connect to multiple different wireless networks. In some cases, generating the multi-SIM capability message includes determining whether the wireless device can receive a first transmission associated with a first SIM card concurrently with a second transmission associated with a second SIM card and generating an indication, for the multi-SIM capability message, whether the wireless device can receive the first transmission concurrently with the second transmission. For example, the wireless device may be connected to multiple wireless carriers concurrently, and the wireless device may indicate such a capability to the wireless network. In some cases, the multi-SIM capability message includes an indication that the wireless device can connect a same wireless network multiple times. In some cases, the wireless device may indicate a receive mode supported by the wireless device. In some cases, the wireless device may indicate a data preference for one of the SIM cards.

At block 1106, the wireless device transmits the multi-SIM capability message to a wireless network. In some cases, the multi-SIM capability message is transmitted to a first wireless network in an attach request message. In some cases, the multi-SIM capability message is transmitted to a first wireless network in a registration request message. In some cases, the wireless device may receive a capability enquiry from a first wireless network, the capability enquiry including an indication inquiring about the multi-SIM capability of the wireless device. The wireless device may transmit the multi-SIM capability message in response to the capability enquiry from the first wireless network. In some cases, the wireless device may receive, from the wireless network, a connection configuration based on the multi-SIM capability message. According to some aspects, the wireless device may include the multi-SIM capability message with each attach request message (and/or Tracking Area Update or registration request message), e.g., if in the previous attach request message (and/or Tracking Area Update or registration request message), the wireless device has still not received indication for support of any of the multi-SIM capabilities from the wireless network

At block 1108, the wireless device receives a registration accept signal (e.g., the aforementioned attach accept message 910, in the case of LTE, and/or the aforementioned registration accept message 1060, in the case of 5G) in response to the multi-SIM capability message, wherein the registration accept signal indicates a first set of features supported by the first wireless network. As mentioned above, the first set of features supported by the first wireless network may comprise at least one of the following: a paging cause feature (1110); a NAS busy indication feature (1112); a paging collision avoidance feature (1114); a NAS leaving procedure feature (1116); a NAS resume procedure feature (1118); or a paging filtering indication feature (1120), which will be described in further detail below.

Paging Cause Feature (1110)

In some cases, the paging cause feature can be applied only for UEs that have explicitly requested it. In other cases, the paging cause feature may be applied to all UEs. (Note: although described here largely in the context of MUSIM UE, a paging cause feature could likewise be employed for usage in the context of a single-USIM UE.) For example, in the case of a 5G network, if the AMF and the UE each support the paging cause function, the AMF may include a paging cause support indication in the aforementioned registration accept message 1060. This indication may, e.g., take the form of a set bit or flag or another information element (IE) included in the registration accept message. In the case of an LTE network, if the MME and the UE each support the paging cause feature, the MME may include a paging cause support indication in the aforementioned attach accept message 910. Again, this indication may, e.g., take the form of a set bit or flag or another variable included in the attach accept message. In non-homogeneous network deployments, NAS-level indication of network support may not be necessary, as all RAN nodes may not support the paging cause feature. Thus, in some aspects, UEs may need to be able to differentiate between a wireless network having no support of the paging cause feature versus a non-voice call indication, e.g., by introducing appropriate cause for non-voice call indication (e.g., in addition to a single paging cause with the meaning of “voice” call for both LTE and 5G).

Other potential values that may be defined for the paging cause feature include: a Short Message Service (SMS) message indication; a messaging indication; an IP Multimedia Subsystem (IMS) service indication; a Control Plane signaling indication; a mission critical service (MCS) page; or an operator-defined application page.

NAS Busy Indication Feature (1112)

In some cases, this NAS busy indication feature may be optional for the UE to support. However, there may be no need for the UE to report having this capability, since the indication of busy is always a UE-initiated event. In the case of a 5G network, if the UE supports MUSIM mode and the AMF supports the busy function, the AMF may include a busy indication support indication in the aforementioned registration accept message 1060. Likewise, in the case of an LTE network, if the UE supports MUSIM mode and the MME supports the busy function, the MME may include a busy indication support indication in the aforementioned attach accept message 910.

As will be described in further detail below, in some cases, the UE may include a busy indication within a service request (SR) response. If the UE response in the SR includes a busy indicator, the AMF/MME may then trigger the release of the NAS connection to the UE after receiving the UE Configuration Update (UCU) complete message. Upon a UE deciding to reject an incoming page and/or send a busy indication, the network may also decide how to handle incoming mobile terminating (MT) data and signaling for the busy UE. For example, the network may decide to buffer the data for a certain amount of time, or simply discard the data outright.

Additionally, in some cases, the UE may be able to specify further details about its busy indication, so that the AMF/MME can make a more informed decision about what action to take with the MT data/signaling that triggered the original paging message. For example, the UE could indicate that it is busy only for the current instance of paging, wherein any new MT data/signaling triggers new paging events for the UE (which may not be responded to with a busy indication). After such a busy indication is received by the AMF/MME, the SMF/S-GW may be informed that only this downlink data notification (DDN) was rejected—but not any future pending DDNs. In other cases, rather than indicating that it is busy only for the current instance of paging, the UE could indicate that it is busy for a pre-defined time duration. In still other cases, the UE could indicate that it is busy until it sends an explicit resume indication to the AMF/MME.

According to these aspects, the UE is able to send a busy indication without having sent a NAS Leaving indication to the network. In such cases, as will be described in further detail below, the UE can include any desired paging filtering information (PFI) in the busy indication itself. Once the UE is ready to return to an active connection on the network, it can explicitly send a resume indication to the network.

NAS Leaving/Resume Procedure Feature (1116/1118)

In some cases, there may be no need for the UE to report having this NAS Leaving/Resume capability, since the indication of NAS leaving or resuming is always a UE-initiated event. In the case of a 5G network, if the UE supports MUSIM mode and the AMF supports the NAS leaving/resuming procedure, the AMF may include a NAS leaving/resuming procedure support indication in the aforementioned registration accept message 1060. Likewise, in the case of an LTE network, if the UE supports MUSIM mode and the MME supports the NAS leaving/resuming procedure, the MME may include a NAS leaving/resuming procedure support indication in the aforementioned attach accept message 910.

In some cases, the UE's connection to a wireless network over non-3GPP access may be exploited for the sending of NAS-level leaving and/or busy indications. For example, if a UE is in a CM-CONNECTED state over both 3GPP access and non-3GPP access on a first SIM card, the UE may take advantage of that and use the non-3GPP access for NAS-level leaving and NAS busy indication procedures related to the 3GPP access (e.g., in response to subsequent incoming pages for the UE on the first SIM card) when the UE decides to enter a connected state or establish an RRC connection with a second wireless network, e.g., using a second SIM card.

In the case of an Evolved Packet System (EPS)/LTE implementation, when the UE indicates a NAS-level leaving procedure, the UE may enter an EPS suspend state in the MME (i.e., ECM-IDLE with active paging filtering information (PFI) in place), meaning the MME will restrict incoming paging to the UE based on the paging filtering information. In some cases, while in the EPS suspend state, the MME may discard all MT services (i.e., no paging at all). However, the UE may also perform periodic mobility measurements or Tracking Area Updates (TAUs) while the EPS suspend state in the MME is still active for the UE. In some cases, the MME shall add a timer to set a maximum time duration to keep the UE suspended. If UE does not respond by the expiration of the timer, the UE may be moved to an ECM-IDLE state.

When the UE comes back to the wireless network, it may issue an explicit NAS resume indication. The UE may also use the resume operation to clear out any existing PFI, so that the UE can resume receiving pages normally. When the UE clears the EPS suspend state in the MME, it may return to an ECM-IDLE state (i.e., ready to receive paging). After the resume operation (assuming no mobile originating (MO) data), the MME can release the NAS signaling, and the UE can enter ECM-IDLE mode quickly.

As mentioned above, in some cases, it may be desirable for the network to employ a timer to decide how long to maintain the stored PFI for a UE. For example, there may be either implicit or explicit resumption of network connection when the leaving operation is guarded by a timer. While a UE has left a network, it may occasionally briefly come back to the PLMN (e.g., to send a busy indication, periodic TAU, or mobile originated SMS (MO-SMS)), but without removing the PFI. In some cases, the UE may indicate in the NAS leaving indication that the UE is not to be paged for a pre-defined duration of time. If the UE returns before the expiry of the pre-defined duration of time, it can trigger a resume indication and resynchronize with the network. If, instead, the UE returns after the expiration of the pre-defined duration of time, then no synchronization with network is needed. The network can simply clear the PFI upon the expiration of the timer.

As alluded to above, in some cases, the UE may also use Service Requests (SRs) and/or TAUs for providing its NAS-level leaving and/or NAS busy indications to the network. In such cases, when a UE in an ECM-Connected state requests NAS-level leaving, it can subsequently perform TAU (including PFI) or SR (including PFI). For example, when a UE actively engaged in a second PLMN (PLMN-2) quickly returns to a first PLMN (PLMN-1) to perform mobility or periodic TAU, it should use TAU including PFI. When the UE is actively engaged in PLMN-2 and quickly returns to PLMN-1 to perform a busy indication, it should use SR with a busy indication. Because the SR is a necessary a response to paging event, leveraging it to signal the busy indication will have no impact on the already established PFI in the MME. When the UE returns to PLMN-1, with or without pending UL data, it should send a resume indication, e.g., a TAU without PFI but with “resume flag” (or other equivalent signal) or a SR without PFI but with a “resume flag” (or other equivalent signal).

In cases where TAUs are to be used for indicating PFI in the NAS leaving message, it may be necessary to send the PFI in every TAU message. Otherwise, in cases where there is a UE context transfer from a MUSIM-supporting MME to a non-supporting MME, the PFI values would be lost. In general, it cannot simply be assumed that paging filtering information will be transferred between network nodes during UE mobility, so it may be preferred for the UE to explicitly send PFI with each TAU.

In some cases, one or more triggers may be used to initiate the NAS leaving procedure for a UE. For example, the UE may initiate a NAS leaving procedure on one USIM only if the activity on the other USIM is a voice call, any activity that involves usage of guaranteed bit rate or guaranteed Quality of Service (QOS) (e.g., VoIP calls). The modem can take indications from upper layers or applications to make this determination. Alternatively, based on UE implementation, NAS leaving can also be triggered for activities where it is known that the other USIM is going to be in an active session for greater than or equal to a predetermined time duration threshold value, and where, during this session, the UE would prefer not to monitor any paging on the SIM where the NAS leaving is to be triggered.

Paging Collision Avoidance Feature (1114)

In some cases, there may be no need for the UE to report having this paging collision avoidance capability. In the case of a 5G network, if the UE supports MUSIM mode and the AMF supports providing International Mobile Subscriber Identifier (IMSI) offset information to assist in paging collision avoidance, the AMF may indicate IMSI offset support (i.e., the adding of an offset value to a UE's IMSI, such that it's paging occasions no longer collide with another UE) in the aforementioned registration accept message 1060. Likewise, in the case of an LTE network, if the UE supports MUSIM mode and the MME supports providing IMSI offset information to assist in paging collision avoidance, the MME may indicate IMSI offset support in the aforementioned attach accept message 910.

Paging Filtering Indication (PFI) Feature (1120)

In the case of a 5G network, if the UE supports MUSIM mode and the AMF supports paging filtering outside of NAS-level leaving procedures, the AMF may indicate paging filtering support in the aforementioned registration accept message 1060. Likewise, in the case of an LTE network, if the UE supports MUSIM mode and the MME supports paging filtering outside of NAS-level leaving procedures, the MME may indicate paging filtering support in the aforementioned attach accept message 910.

In some cases, e.g., in MUSIM context, if the UE is aware that the paging cause feature is not supported by the wireless network, then UE can set the PFI during the NAS leaving procedure. Upon NAS-level leaving, the UE may provide PFI to the wireless network, in order to temporarily restrict/filter MT data in such network while the UE has left. Restrictions may also be based upon at least one of: a particular Packet Data Unit (PDU) session; a particular packet data network (PDN) connection; an indication that the wireless device should only be paged for voice calls; an indication that wireless device should only be paged for predefined paging causes; a particular network slice; a particular traffic class of service; or an indication of a specified duration of time that the wireless device should not be paged.

According to some aspects, the UE may also be allowed to provide information to temporarily restrict and/or filter mobile-terminating (MT) data in other circumstances (i.e., outside of NAS-level leaving procedure). For example, in a first case, a UE may be ECM-Connected over PLMN-1, and then receive a voice call over PLMN-2. Typically, the UE would execute a leaving procedure (e.g., blocking all incoming paging) in PLMN-1, enter into ECM-IDLE with the desired PFI in PLMN-1, and then take up a voice call over PLMN-2, meaning that data sessions are for both PLMNs are activated in parallel. After the call is released, assuming the UE wants to continue its data sessions over PLMN-2, the UE has to trigger a NAS-level resume and a subsequent leaving procedure on PLMN-1, just to inform PLMN-1 that, e.g., it is again available for voice service on PLMN-1. Thus, according to some aspects, instead of performing the resume and a subsequent leaving procedure, the UE may instead perform a single “PFI update” procedure (e.g., as described above by sending an SR with updated PFI or TAU with updated PFI).

In a second case, a UE (e.g., a single-SIM or MUSIM UE) may be battery-constrained. In such cases, the UE can provide PFI to the MME/AMF to restrict paging to only pages related to a predefined set of critical services (e.g., only voice calls).

In a third case, a UE (e.g., a MUSIM UE) may include paging filtering information in a NAS busy indication to update the PFI previously established as part of a NAS-level leaving procedure.

It should also be noted that paging filtering can also be used outside of MUSIM context, i.e., for single-USIM UEs. In the case of a 5G network, if the AMF supports paging filtering, the AMF may indicate paging filtering support in the aforementioned registration accept message 1060. Likewise, in the case of an LTE network, if the MME supports paging filtering, the MME may indicate paging filtering support in the aforementioned attach accept message 910. As may now be understood, according to some aspects, in order to track the PFI, the MME/AMF may store the PFI as a part of each UE's context (i.e., storing an individual page state per each UE).

Returning now to FIG. 11, optionally, at block 1122, the wireless device may connect to the first wireless network based on a first SIM card. Next, at block 1124, the wireless device may connect to a second wireless network based on a second SIM card. At various times during operation, e.g., due to paging collisions, band collisions, possible multi-SIM operation optimizations, multi-SIM suspension/leaving/resumption operations, etc., the wireless device may switch between being actively connected to a wireless network via the first SIM card or the second SIM card. For example, in some cases, a second SIM card may not be used for a predetermined amount of time or unless or until a page comes in related to a to a predefined set of critical services for the second SIM card (e.g., voice calls, mission critical service messages, operator-defined applications, etc.).

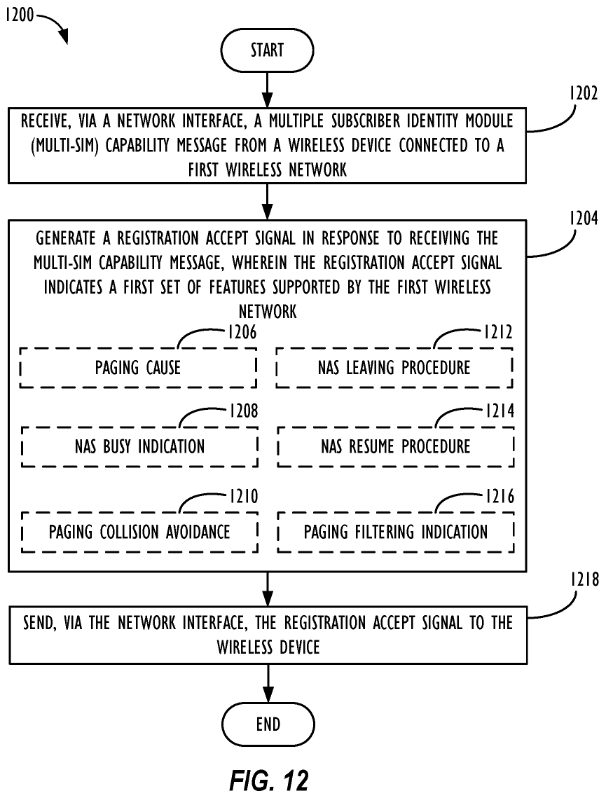

Turning now to FIG. 12, a flowchart 1200 is shown, illustrating a technique for generating multi-SIM feature indications, in accordance with aspects of the present disclosure. At block 1202, an apparatus, e.g., a network element, may receive, via a network interface, a multiple subscriber identity module (multi-SIM) capability message from a wireless device connected to a first wireless network. As mentioned above, this initial capability message could be as simple as an indication that the wireless device supports a MUSIM mode, or it could be as granular as indicating particular features, modes, preferences, etc., supported (or not supported) by the wireless device. Next, at block 1204, the apparatus may generate a registration accept signal in response to receiving the multi-SIM capability message, wherein the registration accept signal indicates a first set of features supported by the first wireless network. As described above with reference to FIG. 11, the first set of features supported by the first wireless network may comprise at least one of the following: a paging cause feature (1206); a NAS busy indication feature (1208); a paging collision avoidance feature (1210); a NAS leaving procedure feature (1212); a NAS resume procedure feature (1214); or a paging filtering indication feature (1216). Finally, at block 1218, the apparatus may send, via the network interface, the registration accept signal (which indicates the first set of features supported by the first wireless network) to the wireless device.

Message Sequence Diagrams

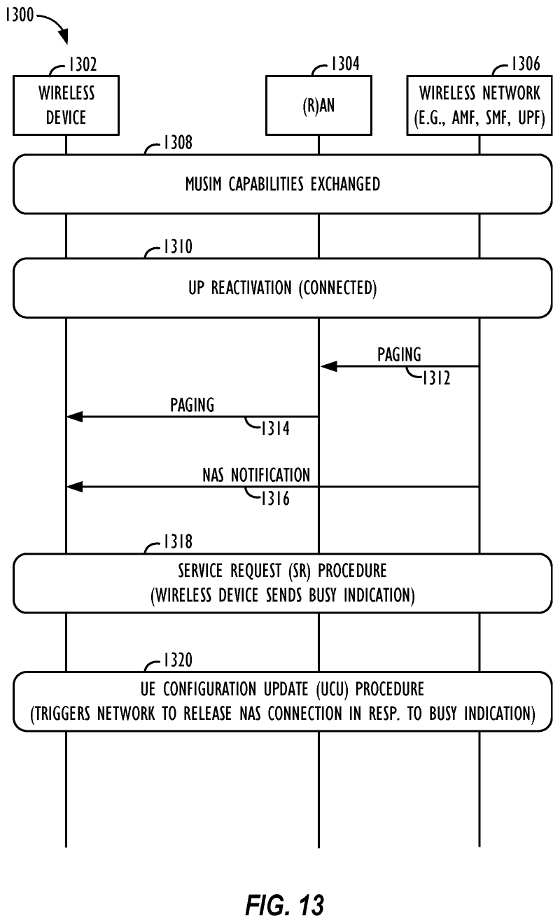

Turning now to FIG. 13, a message sequence diagram 1300 is shown, illustrating a multi-SIM wireless device NAS busy indication process, in accordance with aspects of the present disclosure. Message sequence diagram 1300 involves an exemplary wireless device (e.g., a UE) 1302, an exemplary (Radio) Access Network 1304, and an exemplary wireless network 1306 (including, e.g., the AMF/MME, SMF, UPF, etc.). First, at step 1308, MUSIM capabilities may be exchanged between the wireless device 1302 and the wireless network 1306, e.g., as described above. Next, at step 1310, the wireless device 1302 may activate (or reactivate) its user plane (UP) connection with the wireless network 1306. At steps 1312 and 1314, a paging message, e.g., in the form of a paging request for a PDU session associated to 3GPP access, is sent from wireless network 1306 (e.g., via the MME/AMF), via RAN 1304, to wireless device 1302. At step 1316, a NAS notification of the page (e.g., carrying the paging information and/or the paging cause) is sent from the wireless network 1306 to wireless device 1302. At step 1318, the wireless device responds to the page using the SR procedure, in this case, deciding not to accept the paging and instead using the triggered SR to send the busy indication to the wireless network. Next, at step 1320, the UE Configuration Update (UCU) procedure is completed to acknowledge the SR. For example, if the MME/AMF has paged the UE to trigger the SR procedure, the MME/AMF shall initiate the UCU procedure to assign a new 5G-globally unique temporary identifier (5G-GUTI). If the UE response in the SR includes a busy indicator, the MME/AMF may immediately trigger the release of NAS connection after receiving the UCU complete message.

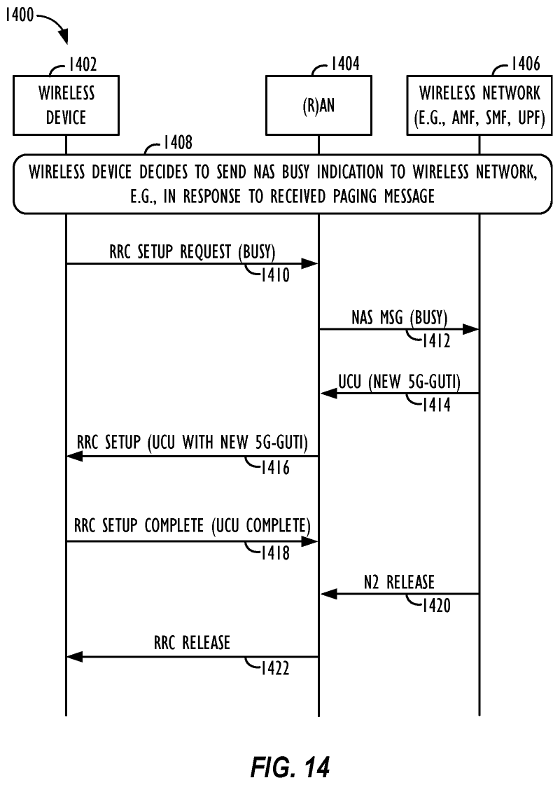

Turning now to FIG. 14, a message sequence diagram 1400 is shown, illustrating an optimized multi-SIM wireless device NAS busy indication process, in accordance with aspects of the present disclosure. Again, message sequence diagram 1400 involves an exemplary wireless device 1402, an exemplary (Radio) Access Network 1404, and an exemplary wireless network 1406. First, at step 1408, the wireless device 1402 may decide to send a NAS busy indication to the wireless network 1406, e.g., in response to a received paging message. Next, at step 1410, as part of the RRC setup request process, the wireless device 1402 may indicate its busy status to RAN 1404, which may then be passed along, e.g., in the form of a NAS-busy message at step 1412, to the MME/AMF of wireless network 1406. In response, at step 1414, wireless network 1406, via the MME/AMF, shall initiate the UCU procedure to assign a new 5G-GUTI to the wireless device 1402. At step 1416, the RRC setup may proceed with the RAN 1404 passing the 5G-GUTI to the wireless device 1402. At step 1418, the RRC setup process may be completed, with the wireless device 1402 sending the UCU complete message back to RAN 1404. Finally, at step 1420, an N2 release message (wherein N2 refers to the control plane interface between an Access Network and the 5G core) may be passed from wireless network 1406 to RAN 1404, which, in turn, may pass the RRC release message to the wireless device 1402 at Step 1422. As may now be understood, the process shown in FIG. 14 is able to minimize the number of messages exchanged to send NAS busy indications, compared with current practice, so the impact to other UE SIM activity is minimal.

According to other aspects, rather than exchanging NAS messages for the busy indication, the wireless network can use a unique establishment cause, e.g., in the RRC connection request message, to deduce that the wireless device is busy and then inform the same to the MME/AMF. The MME/AMF, in turn, can notify the wireless network to release the connection and also provide a new 5G-GUTI to be provided to the wireless device. According to other aspects, the wireless network can indicate the new 5G-GUTI to the UE in the RRC connection release message. The RRC connection release could be sent directly after receiving the RRC connection request with establishment cause that indicates that the wireless device is busy. Alternatively, the wireless network could also allow the wireless device to move to a connected state and subsequently provide the 5G-GUTI in the RRC connection release message.

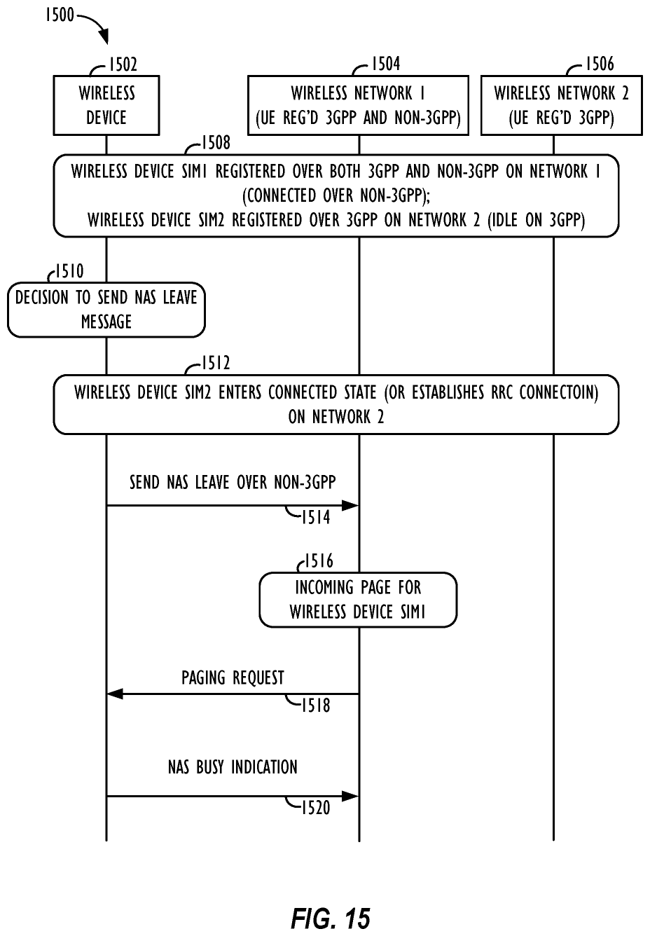

Turning now to FIG. 15, a message sequence diagram 1500 is shown, illustrating multi-SIM wireless device NAS busy/leaving indication with multiple wireless networks, in accordance with aspects of the present disclosure. Message sequence diagram 1500 involves an exemplary wireless device 1502, a first exemplary wireless network 1504, and a second exemplary wireless network 1506. First, at step 1508, the wireless device 1502 may have a first SIM card, SIM1, registered over both 3GPP and non-3GPP on a first wireless network, i.e., wireless network 1 1504, and connected over non-3GPP access. Wireless device 1502 may also have a second SIM card, SIM2, registered over 3GPP access on a second wireless network, i.e., wireless network 2 1506, and in an idle state. Next, at step 1510, the wireless device 1502 may decide to send a NAS-level leave message regarding its registration over 3GPP access on wireless network 1 1504. At Step 1512, the wireless device 1502 may enter a connected state (or establishes RRC connection) on wireless network 2 1506 over 3GPP access. Next, at Step 1514, the wireless device 1502 may send a NAS-level leave message regarding its registration to a core network (CN) over 3GPP access on wireless network 1 1504 using its non-3GPP access on wireless network 1 1504. Then, if, as shown at step 1516, an incoming page comes for wireless device 1502 over wireless network 1 1504, the paging request may be sent at step 1518 to wireless device 1502, and the wireless device 1502 may respond be sending a NAS busy indication using its non-3GPP access on wireless network 1 1504. As may now be understood, the process shown in FIG. 15 is able to take advantage of a wireless device's non-3GPP access for typical NAS-level leaving and NAS busy indication procedures. As a concrete example of the illustrated process in FIG. 15, if a UE was registered with parallel cellular and Wi-Fi access, it could use the Wi-Fi access to send the NAS-level leave or busy indication for the UE, such that the UE doesn't have to be in an IDLE mode (or otherwise connected to cellular access) in order to send its NAS-level indications. In some cases, the message sent over Wi-Fi could even explicitly or implicitly indicate that it belonged to the UE's cellular access (i.e., rather than the Wi-Fi access that it was arriving via).

### Examples

In the following sections, further exemplary aspects are provided.

According to Example 1, a wireless communication method for a wireless device is disclosed, comprising: determining that the wireless device supports using multiple subscriber identity module (SIM) cards to establish multiple connections to wireless networks; generating a multi-SIM capability message; transmitting the multi-SIM capability message to a first wireless network; and receiving a registration accept signal in response to the multi-SIM capability message, wherein the registration accept signal indicates a first set of features supported by the first wireless network.

Example 2 comprises the subject matter of example 1, wherein the multi-SIM capability message includes an indication that the wireless device supports using multiple SIM cards to establish multiple connections to wireless networks.

Example 3 comprises the subject matter of example 2, further comprising: connecting to the first wireless network with 3rd Generation Partnership Project (3GPP)-compliant access with a first SIM card; connecting to a second wireless network with non-3GPP-compliant access with a second SIM card; and using the second wireless network to transmit, to a core network (CN), a Non-Access Stratum (NAS) busy indication or a NAS leaving indication related to the wireless device's connection to the first wireless network.

Example 4 comprises the subject matter of example 1, wherein the first set of features supported by the first wireless network comprises at least one of the following: a paging cause feature; a Non-Access Stratum (NAS) busy indication feature; a paging collision avoidance feature; a NAS leaving procedure feature; a NAS resume procedure feature; or a paging filtering indication feature.

Example 5 comprises the subject matter of example 1, wherein the multi-SIM capability message indicates a second set of features supported by the wireless device.

Example 6 comprises the subject matter of example 5, wherein the first set of features supported by the first wireless network and the second set of features supported by the wireless device are different.

Example 7 comprises the subject matter of example 4, wherein the paging cause feature comprises an indication of a cause of a page sent to the wireless device.

Example 8 comprises the subject matter of example 7, wherein the cause of the page sent to the wireless device comprises at least one of the following: a voice call indication; a non-voice call indication; a Short Message Service (SMS) message indication; a messaging indication; an IP Multimedia Subsystem (IMS) service indication; a Control Plane signaling indication; a mission critical service page; or an operator-defined application page.

Example 9 comprises the subject matter of example 4, wherein the NAS busy indication comprises a signal triggered by a Radio Resource Control (RRC) setup request message sent from the wireless device.

Example 10 comprises the subject matter of example 4, wherein the NAS busy indication comprises a signal sent from the wireless device to the first wireless network, and wherein the NAS busy indication further comprises a paging filtering indication.

Example 11 comprises the subject matter of example 10, wherein the paging filtering indication comprises an indication of how the first wireless network should handle incoming pages while the wireless device is busy.

Example 12 comprises the subject matter of example 11, wherein the paging filtering indication further comprises an indication of at least one of the following conditions: that the wireless device is busy only for a current instance of paging; that the wireless device is busy for a specified time duration; or that the wireless device is busy until it sends an explicit resume indication to the first wireless network.

Example 13 comprises the subject matter of example 11, wherein the paging filtering indication further comprises an indication that the first wireless network should filter pages for the wireless device based on at least one of: a particular Packet Data Unit (PDU) session; a particular packet data network (PDN) connection; an indication that the wireless device should only be paged for voice calls; an indication that wireless device should only be paged for predefined paging causes; a particular network slice; a particular traffic class of service; or an indication of a specified duration of time that the wireless device should not be paged.

Example 14 comprises the subject matter of example 4, wherein the paging collision avoidance feature comprises an indication of an International Mobile Subscriber Identifier (IMSI) offset support sent to the wireless device.

Example 15 comprises the subject matter of example 4, wherein the NAS leaving indication comprises a signal sent from the wireless device to the first wireless network, and wherein the NAS leaving indication further comprises a paging filtering indication.

Example 16 comprises the subject matter of example 15, wherein the paging filtering indication comprises an indication of how the first wireless network should handle incoming pages while the wireless device is active on a different wireless network.

Example 17 comprises the subject matter of example 16, wherein the paging filtering indication further comprises an indication that the first wireless network should filter pages for the wireless device based on at least one of: a particular Packet Data Unit (PDU) session; a particular packet data network (PDN) connection; an indication that the wireless device should only be paged for voice calls; an indication that wireless device should only be paged for predefined paging causes; a particular network slice; a particular traffic class of service; or an indication of a specified duration of time that the wireless device should not be paged.

Example 18 comprises the subject matter of example 4, wherein the paging filtering indication comprises a signal sent from the wireless device to the first wireless network to do at least one of the following: update a previously sent paging filtering indication; restrict paging to only voice calls; or restrict paging to only pages related to a predefined set of critical services.

Example 19 comprises the subject matter of example 18, wherein the paging filtering indication comprises a signal sent from the wireless device to the first wireless network to update a previously sent paging filtering indication, and wherein the updated paging filtering indication is sent via at least one of the following: a service request (SR) message; or a tracking area update (TAU) message.

Example 20 comprises the subject matter of example 4, wherein the NAS leaving indication comprises a signal sent from the wireless device to the first wireless network, and wherein the NAS leaving indication further comprises a paging filtering indication causing the first wireless network to place the wireless device into a suspended state and discard all pages for the wireless device for up to a predefined maximum time duration.

Example 21 comprises the subject matter of example 20, wherein the paging filtering indication is cleared by the first wireless network in response to the wireless device resuming an active connection status with the first wireless network prior to the expiry of the predefined maximum time duration.

Example 22 comprises the subject matter of example 20, wherein the paging filtering indication is cleared by the first wireless network in response to the wireless device not resuming an active connection status with the first wireless network prior to the expiry of the predefined maximum time duration.

Example 23 comprises the subject matter of example 4, wherein at least one of the NAS busy indication or the NAS leaving procedure feature comprises the wireless device sending at least one of the following to the first wireless network: a service request (SR) message comprising paging filtering information; or a tracking area update (TAU) message comprising paging filtering information.

Example 24 comprises the subject matter of example 4, wherein the NAS resume procedure feature comprises the wireless device sending at least one of the following to the first wireless network: a service request (SR) message without paging filtering information; or a tracking area update (TAU) message without paging filtering information.

Example 25 comprises the subject matter of example 4, wherein the NAS leaving procedure feature comprises the wireless device sending a message to the first wireless network using a first SIM card of the multiple SIM cards, in response to determining that an activity is taking place on a second SIM card of the multiple SIM cards that involves: a) a guaranteed bit rate; b) a guaranteed quality of service (QoS); or c) greater than or equal to a predetermined time duration threshold value.

According to example 26, a wireless communications apparatus is disclosed, comprising: a memory; a network interface; one or more processors coupled to the memory, wherein the one or more processors are configured to perform operations, comprising: receiving, via the network interface, a multiple subscriber identity module (multi-SIM) capability message from a wireless device connected to a first wireless network; generating a registration accept signal in response to receiving the multi-SIM capability message, wherein the registration accept signal indicates a first set of features supported by the first wireless network; and sending, via the network interface, the registration accept signal to the wireless device.

Example 27 comprises the subject matter of example 26, wherein the multi-SIM capability message includes an indication that the wireless device supports using multiple SIM cards to establish multiple connections to wireless networks.

Example 28 comprises the subject matter of example 26, wherein the first set of features supported by the first wireless network comprises at least one of the following: a paging cause feature; a Non-Access Stratum (NAS) busy indication feature; a paging collision avoidance feature; a NAS leaving procedure feature; a NAS resume procedure feature; or a paging filtering indication feature.

Example 29 comprises the subject matter of example 28, wherein the paging cause feature comprises an indication of a cause of a page sent to the wireless device.

Example 30 comprises the subject matter of example 28, wherein the NAS busy indication comprises a signal triggered by a Radio Resource Control (RRC) setup request message sent from the wireless device.

Example 31 comprises the subject matter of example 30, wherein the one or more processors are further configured to perform operations, comprising: sending a User Equipment Configuration Update (UCU) message to the wireless device, in response to receiving the NAS busy indication from the wireless device.

Example 32 comprises the subject matter of example 28, wherein the NAS busy indication comprises a signal sent from the wireless device to the apparatus, and wherein the NAS busy indication further comprises a paging filtering indication.

Example 33 comprises the subject matter of example 32, wherein the paging filtering indication further comprises an indication of at least one of the following conditions: that the wireless device is busy only for a current instance of paging; that the wireless device is busy for a specified time duration; or that the wireless device is busy until it sends an explicit resume indication to the apparatus.

Example 34 comprises the subject matter of example 32, wherein the paging filtering indication further comprises an indication that the apparatus should filter pages for the wireless device based on at least one of: a particular Packet Data Unit (PDU) session; a particular packet data network (PDN) connection; an indication that the wireless device should only be paged for voice calls; an indication that wireless device should only be paged for predefined paging causes; or an indication of a specified duration of time that the wireless device should not be paged.

Example 35 comprises the subject matter of example 28, wherein the paging collision avoidance feature comprises an indication of an International Mobile Subscriber Identifier (IMSI) offset support sent to the wireless device.

Example 36 comprises the subject matter of example 28, wherein the NAS leaving indication comprises a signal sent from the wireless device to the apparatus, and wherein the NAS leaving indication further comprises a paging filtering indication.

Example 37 comprises the subject matter of example 36, wherein the paging filtering indication further comprises an indication that the apparatus should filter pages for the wireless device based on at least one of: a particular Packet Data Unit (PDU) session; a particular packet data network (PDN) connection; an indication that the wireless device should only be paged for voice calls; an indication that wireless device should only be paged for predefined paging causes; or an indication of a specified duration of time that the wireless device should not be paged.

Example 38 comprises the subject matter of example 28, wherein the paging filtering indication comprises a signal sent from the wireless device to the apparatus to do at least one of the following: update a previously sent paging filtering indication for the wireless device; restrict paging to the wireless device to only voice calls; or restrict paging to the wireless device to only pages related to a predefined set of critical services.

Example 39 comprises the subject matter of example 38, wherein the paging filtering indication comprises a signal sent from the wireless device to the apparatus to update a previously sent paging filtering indication for the wireless device, and wherein the updated paging filtering indication is sent via at least one of the following: a service request (SR) message; or a tracking area update (TAU) message.

Example 40 comprises the subject matter of example 28, wherein the NAS leaving indication comprises a signal sent from the wireless device to the apparatus, and wherein the NAS leaving indication further comprises a paging filtering indication causing the apparatus to place the wireless device into a suspended state and discard all pages for the wireless device for up to a predefined maximum time duration.

Example 41 comprises the subject matter of example 40, wherein the paging filtering indication is cleared by the apparatus in response to the wireless device resuming an active connection status with the first wireless network prior to the expiry of the predefined maximum time duration.

Example 42 comprises the subject matter of example 40, wherein the paging filtering indication is cleared by the apparatus in response to the wireless device not resuming an active connection status with the first wireless network prior to the expiry of the predefined maximum time duration.

Example 43 comprises the subject matter of example 28, wherein at least one of the NAS busy indication or the NAS leaving procedure feature comprises the wireless device sending at least one of the following to the apparatus: a service request (SR) message comprising paging filtering information; or a tracking area update (TAU) message comprising paging filtering information.

Example 44 comprises the subject matter of example 28, wherein the NAS resume procedure feature comprises the wireless device sending at least one of the following to the apparatus: a service request (SR) message without paging filtering information; or a tracking area update (TAU) message without paging filtering information.

Example 45 comprises the subject matter of example 28, wherein the NAS leaving procedure feature comprises the wireless device sending a message to the apparatus using a first SIM card, in response to determining that an activity is taking place on a second SIM that involves: a) a guaranteed bit rate; b) a guaranteed quality of service (QoS); or c) greater than or equal to a predetermined time duration threshold value.

According to example 46, a wireless communications apparatus is disclosed, comprising: a memory; a network interface; one or more processors coupled to the memory, wherein the one or more processors are configured to perform operations, comprising: receiving, via the network interface, a multiple subscriber identity module (multi-SIM) capability message from a wireless device connected to a first wireless network; generating a registration accept signal in response to receiving the multi-SIM capability message, wherein the registration accept signal indicates a first set of features supported by the first wireless network; sending, via the network interface, the registration accept signal to the wireless device; receiving, via the network interface, a Non-access stratum (NAS) leaving indication from the wireless device; receiving, via the network interface, paging filtering information (PFI) from the wireless device; and storing, in the memory, the PFI for the wireless device.

Example 47 comprises the subject matter of example 46, wherein the paging filtering indication further comprises an indication that the apparatus should filter pages for the wireless device based on at least one of: a particular Packet Data Unit (PDU) session; a particular packet data network (PDN) connection; an indication that the wireless device should only be paged for voice calls; an indication that wireless device should only be paged for predefined paging causes; or an indication of a specified duration of time that the wireless device should not be paged.

Example 48 comprises the subject matter of example 46, wherein the paging filtering indication causes the apparatus to place the wireless device into a suspended state and discard all pages for the wireless device for up to a predefined maximum time duration.

Example 49 comprises the subject matter of example 48, wherein the paging filtering indication is cleared by the apparatus in response to the wireless device resuming an active connection status with the first wireless network prior to the expiry of the predefined maximum time duration.

Example 50 comprises the subject matter of example 48, wherein the paging filtering indication is cleared by the apparatus in response to the wireless device not resuming an active connection status with the first wireless network prior to the expiry of the predefined maximum time duration.

Example 51 comprises the subject matter of example 46, wherein the NAS leaving indication further comprises at least one of: a service request (SR) message comprising the paging filtering information; or a tracking area update (TAU) message comprising the paging filtering information.

Example 52 comprises the subject matter of example 46, wherein the apparatus is configured to implement a mobility management entity (MME); or an access and management function (AMF).

According to example 53, a wireless communications apparatus is disclosed, comprising: a memory; a network interface; one or more processors coupled to the memory, wherein the one or more processors are configured to perform operations, comprising: receiving, via the network interface, a multiple subscriber identity module (multi-SIM) capability message from a wireless device connected to a first wireless network; generating a registration accept signal in response to receiving the multi-SIM capability message, wherein the registration accept signal indicates a first set of features supported by the first wireless network; sending, via the network interface, the registration accept signal to the wireless device; receiving, via the network interface, a request from the wireless device to activate its user plane (UP) connection with the first wireless network; sending, via the network interface, a paging message to the wireless device; and receiving, via the network interface, an indication from the wireless device that it does not accept the paging message.

Example 54 comprises the subject matter of example 53, wherein the paging message comprises a paging request for a Packet Data Unit (PDU) session.

Example 55 comprises the subject matter of example 53, wherein the indication from the wireless device that it does not accept the paging message is received using a service request (SR) procedure.

Example 56 comprises the subject matter of example 55, wherein the SR procedure comprises a busy indication for the wireless device.

Example 57 comprises the subject matter of example 55, wherein the one or more processors are further configured to perform operations, comprising: completing a UE Configuration Update (UCU) procedure to acknowledge the SR.

Example 58 comprises the subject matter of example 57, wherein the one or more processors are further configured to perform operations, comprising: assigning a new 5G-globally unique temporary identifier (5G-GUTI) to the wireless device.

Example 59 comprises the subject matter of example 56, wherein the one or more processors are further configured to perform operations, comprising: completing a UE Configuration Update (UCU) procedure to acknowledge the SR.

Example 60 comprises the subject matter of example 59, wherein the one or more processors are further configured to perform operations, comprising: releasing a NAS connection to the wireless device.

According to Example 61, a method that includes any action or combination of actions as substantially described herein in the Detailed Description.

According to Example 62, a method as substantially described herein with reference to each or any combination of the Figures included herein or with reference to each or any combination of paragraphs in the Detailed Description.

According to Example 63, a wireless device configured to perform any action or combination of actions as substantially described herein in the Detailed Description as included in the wireless device.

According to Example 64, a wireless network element configured to perform any action or combination of actions as substantially described herein in the Detailed Description as included in the wireless network element.

Example 65 comprises the subject matter of example 64, wherein the wireless element implements one or more of the following: a mobility management entity (MME); a serving gateway (S-GW); an access and management function (AMF); a session management function (SMF); a user plane function (UPF); or a network slice quota management (NSQM) function.

According to Example 66, a wireless station configured to perform any action or combination of actions as substantially described herein in the Detailed Description as included in the wireless station.

According to Example 67, a non-volatile computer-readable medium that stores instructions that, when executed, cause the performance of any action or combination of actions as substantially described herein in the Detailed Description.

According to Example 68, an integrated circuit configured to perform any action or combination of actions as substantially described herein in the Detailed Description.

Yet another exemplary aspect may include a method, comprising, by a device, performing any or all parts of the preceding Examples.

A yet further exemplary aspect may include a non-transitory computer-accessible memory medium comprising program instructions which, when executed at a device, cause the device to implement any or all parts of any of the preceding Examples.

A still further exemplary aspect may include a computer program comprising instructions for performing any or all parts of any of the preceding Examples.

Yet another exemplary aspect may include an apparatus comprising means for performing any or all of the elements of any of the preceding Examples.

Still another exemplary aspect may include an apparatus comprising a processor configured to cause a device to perform any or all of the elements of any of the preceding Examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method, e.g., any of a method aspects described herein, or, any combination of the method aspects described herein, or, any subset of any of the method aspects described herein, or, any combination of such subsets.

In some aspects, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless communication method for a wireless device, comprising:
determining that the wireless device supports using multiple subscriber identity module (SIM) cards to establish multiple connections to wireless networks;
generating a multi-SIM capability message;
transmitting the multi-SIM capability message to a first wireless network; and
receiving a registration accept signal in response to the multi-SIM capability message, wherein the registration accept signal indicates a first set of features supported by the first wireless network.

2. The method of claim 1, wherein the multi-SIM capability message includes an indication that the wireless device supports using multiple SIM cards to establish multiple connections to wireless networks.

3. The method of claim 1, wherein the first set of features supported by the first wireless network comprises at least one of the following: a paging cause feature; a Non-Access Stratum (NAS) busy indication feature; a paging collision avoidance feature; a NAS leaving procedure feature; a NAS resume procedure feature; or a paging filtering indication feature.

4. The method of claim 3, wherein the paging cause feature comprises an indication of a cause of a page sent to the wireless device.

5. The method of claim 4, wherein the cause of the page sent to the wireless device comprises at least one of the following: a voice call indication; a non-voice call indication; a Short Message Service (SMS) message indication; a messaging indication; an IP Multimedia Subsystem (IMS) service indication; a Control Plane signaling indication; a mission critical service page; or an operator-defined application page.

6. The method of claim 3, wherein the NAS busy indication comprises a signal triggered by a Radio Resource Control (RRC) setup request message sent from the wireless device.

7. The method of claim 3, wherein the NAS busy indication comprises a signal sent from the wireless device to the first wireless network.

8. The method of claim 7, wherein the NAS busy indication further comprises a paging filtering indication and wherein the paging filtering indication comprises an indication of how the first wireless network should handle incoming pages while the wireless device is busy.

9. The method of claim 8, wherein the paging filtering indication further comprises an indication of at least one of the following conditions: that the wireless device is busy only for a current instance of paging; that the wireless device is busy for a specified time duration; or that the wireless device is busy until it sends an explicit resume indication to the first wireless network.

10. The method of claim 3, wherein the NAS leaving indication comprises a signal sent from the wireless device to the first wireless network, and wherein the NAS leaving indication further comprises a paging filtering indication.

11. The method of claim 10, wherein the paging filtering indication comprises an indication of how the first wireless network should handle incoming pages while the wireless device is active on a different wireless network.

12. The method of claim 11, wherein the paging filtering indication further comprises an indication that the first wireless network should filter pages for the wireless device based on at least one of: a particular Packet Data Unit (PDU) session; a particular packet data network (PDN) connection; an indication that the wireless device should only be paged for voice calls; an indication that wireless device should only be paged for predefined paging causes; a particular network slice; a particular traffic class of service; or an indication of a specified duration of time that the wireless device should not be paged.

13. A wireless communications apparatus, comprising:
a memory;
a network interface;
one or more processors coupled to the memory, wherein the one or more processors are configured to perform operations, comprising:
receiving, via the network interface, a multiple subscriber identity module (multi-SIM) capability message from a wireless device connected to a first wireless network;
generating a registration accept signal in response to receiving the multi-SIM capability message, wherein the registration accept signal indicates a first set of features supported by the first wireless network; and
sending, via the network interface, the registration accept signal to the wireless device.

14. The apparatus of claim 13, wherein the multi-SIM capability message includes an indication that the wireless device supports using multiple SIM cards to establish multiple connections to wireless networks.

15. The apparatus of claim 13, wherein the first set of features supported by the first wireless network comprises at least one of the following: a paging cause feature; a Non-Access Stratum (NAS) busy indication feature; a paging collision avoidance feature; a NAS leaving procedure feature; a NAS resume procedure feature; or a paging filtering indication feature.

16. The apparatus of claim 15, wherein the paging cause feature comprises an indication of a cause of a page sent to the wireless device.

17. The apparatus of claim 15, wherein the NAS busy indication comprises a signal sent from the wireless device to the apparatus.

18. The apparatus of claim 17, wherein the NAS busy indication further comprises a paging filtering indication and wherein the paging filtering indication further comprises an indication of at least one of the following conditions: that the wireless device is busy only for a current instance of paging; that the wireless device is busy for a specified time duration; or that the wireless device is busy until it sends an explicit resume indication to the apparatus.

19. A wireless device, comprising:
a memory;
a network interface;
one or more processors coupled to the memory, wherein the one or more processors are configured to perform operations, comprising:
determine that the wireless device supports using multiple subscriber identity module (SIM) cards to establish multiple connections to wireless networks;
generate a multi-SIM capability message;
transmit the multi-SIM capability message to a first wireless network; and
receive a registration accept signal in response to the multi-SIM capability message, wherein the registration accept signal indicates a first set of features supported by the first wireless network.

20. The wireless device of claim 19, wherein the multi-SIM capability message includes an indication that the wireless device supports using multiple SIM cards to establish multiple connections to wireless networks.
